(19) United States
(12) Patent Application Publication
(10) Pub. No.: US 2011/0267307 A1
(43) Pub. Date: Nov. 3, 2011

(54) DISPLAY DEVICE HAVING TOUCH SCREEN

(75) Inventors: Woon Chun Kim, Gyunggi-do (KR); Yong Soo Oh, Gyunggi-do (KR); Jong Young Lee, Suwon (KR)

(73) Assignee: SAMSUNG ELECTRO-MECHANICS CO., LTD., Gyeonggi-do (KR)

(21) Appl. No.: 12/882,080

(22) Filed: Sep. 14, 2010

(30) Foreign Application Priority Data
May 3, 2010 (KR) 10-2010-0041579

(51) Int. Cl. G06F 3/041

(52) U.S. Cl. 345/174; 345/173

(57) ABSTRACT

Disclosed herein is a display device having a touch screen, including: a display unit, a touch screen that is positioned on the upper side of the display unit, a double-sided adhesive sheet that is positioned between the display unit and the touch screen and is disposed in the edge region of the touch screen to bond the display unit to the touch screen, and an optical transparent sheet that is positioned inside the double-sided adhesive sheet and is bonded to the touch screen and is contacted to the display unit.

### CROSS REFERENCE TO RELATED APPLICATION

This application claims the benefit of Korean Patent Application No. 10-2010-0041579, filed on May 3, 2010, entitled “Display Device Having Touch Screen”, which is hereby incorporated by reference in its entirety into this application.

### BACKGROUND OF THE INVENTION

1. Technical Field

The present invention relates to a display device having a touch screen.

2. Description of the Related Art

With the development of the mobile communication technology, user terminals such as cellular phones, PDAs, and navigations can serve as a display unit that simply displays character information as well serve as a unit for providing various and complex multi-media such as audio, moving picture, radio Internet web browser, etc.

Therefore, electronic information terminals having a limited size require a larger display screen, such that a display device using a touch screen has become the main focus

A touch screen is disposed over a display to have a configuration integral with the display, and a user selects a target image using the touch screen.

When a touch screen according to the prior art is disposed over the display, there is a predetermined interval between the touch screen and the display. According to the prior method, there is an air gap between the touch screen and the display, such that transmittance of an image generated from the display is degraded.

In order to solve this problem, the touch screen is bonded to the entire surface of the display using a double-sided adhesive sheet, thereby removing the air gap. When defects occur in the touch screen, however, this method has disadvantages in that it is not easy to detach the touch screen from the display and the adhesive leaves stains over the display. Therefore, the defects of the touch screen may even lead to damaging beyond repair of the display.

### SUMMARY OF THE INVENTION

The present invention has been made in an effort to provide a display device having a touch screen that removes an air gap between a touch screen and a display by using a double-sided adhesive sheet and an optical transparent sheet when bonding the touch screen to the display and allows the optical transparent sheet to be bonded to the touch screen and to be contacted to the display to allow the touch screen to be easily detached from the display when defects occur in the touch screen.

A display device having a touch screen according to a preferred embodiment of the present invention includes: a display unit; a touch screen that is positioned on the upper side of the display unit; a double-sided adhesive sheet that is positioned between the display unit and the touch screen and is disposed in the edge region of the touch screen to bond the display unit to the touch screen; and an optical transparent sheet that is positioned inside the double-sided adhesive sheet and is bonded to the touch screen and is contacted to the display unit.

Further, the optical transparent sheet has the same thickness as that of the double-sided adhesive sheet.

Further, the inner side surface of the double-sided adhesive sheet contacts the outer side surface of the optical transparent sheet positioned inside the double-sided adhesive sheet.

Further, the outer side surface of the optical transparent sheet is surrounded by the inner side surface of the double-sided adhesive sheet.

Further, the display unit is an LCD.

Further, the display unit is an OLED.

Further, the touch screen is a capacitive touch screen.

Further, the touch screen is a resistive touch screen.

### BRIEF DESCRIPTION OF THE DRAWINGS

FIG. 1 is an exploded perspective view of a display device having a touch screen according to a preferred embodiment of the present invention;

FIG. 2 is an exploded perspective view showing a modified example of the display device having a touch screen of FIG. 1;

FIG. 3 is a cross-sectional view schematically showing an LCD as a display unit that can be used in FIG. 1;

FIG. 4 is a cross-sectional view schematically showing an OLED as a display unit that can be used in FIG. 1;

FIG. 5 is an exploded perspective view of a touch screen that can be used in FIG. 1; and

FIG. 6 is an exploded perspective view of another touch screen that can be used in FIG. 1.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

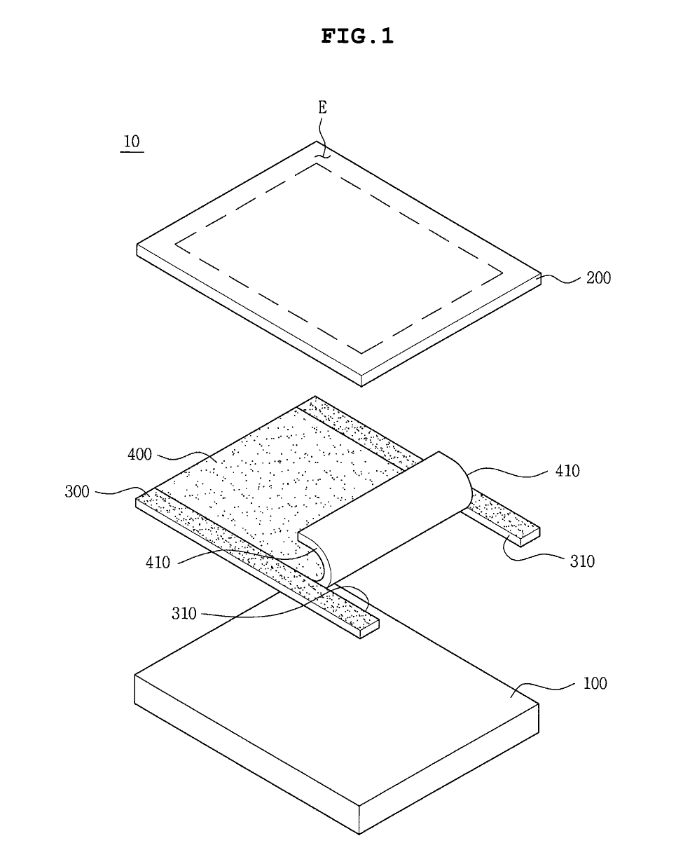

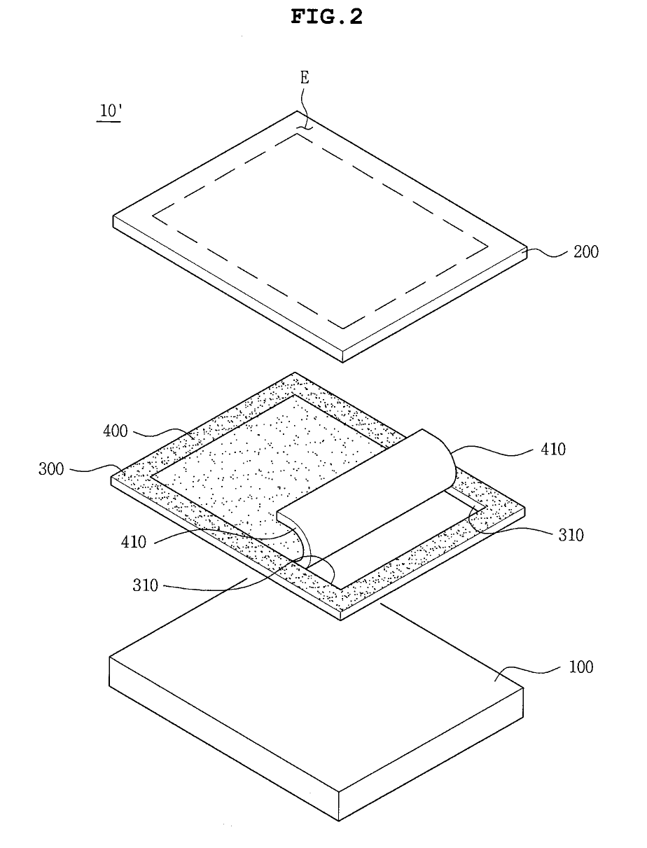

FIG. 1 is an exploded perspective view of a display device having a touch screen according to a preferred embodiment of the present invention, and FIG. 2 is an exploded perspective view showing a modified example of the display device having a touch screen of FIG. 1. Hereinafter, a display device having a touch screen according to the present embodiment will be described with reference to the figures.

As shown in FIG. 1, a display device 10 having a touch screen 10 (hereinafter, referred to as a display device) according to the present invention is configured to include a display unit 100 and a touch screen 200 that is positioned on the upper side of the display unit, wherein the display unit 100 is bonded to the touch screen 200 by an adhesive layer. At this time, the adhesive layer is configured of a double-sided adhesive sheet 300 and an optical transparent sheet 400.

At this time, the double-sided adhesive sheet 300 is disposed in an edge region E of the touch screen 200, and the optical transparent sheet 400 is positioned inside the double-sided adhesive sheet 300. The double-sided adhesive sheet 300 serves to bond the display unit 100 to the touch screen 200, and the optical transparent sheet 400 serves to remove an air gap between the display unit 100 and the touch screen 200.

Reviewing the structure and function of the adhesive layer in detail, first, the double-sided adhesive sheet 300 is positioned between the display unit 100 and the touch screen 200 and is disposed in the edge region of the touch screen 200, thereby bonding the display unit 100 to the touch screen 200.

At this time, the edge region of the touch screen 200, through which an image generated from the display does not pass, is a region in which electrode wirings connected to electrode patterns of the touch screen 200 are positioned.

The double-sided adhesive sheet 300 does not need to cover all of the edge regions but may be positioned at two edge portions opposite to each other, as shown in FIG. 1. In other words, the disposition of the double-sided adhesive sheet 300 positioned in the edge region of the touch screen 200 may vary in the range capable of bonding the display unit 100 to the touch screen 200.

The optical transparent sheet 400 is positioned inside the double-sided adhesive sheet 300, is bonded to the touch, screen 200, and is contacted with the display unit 100. The double-sided adhesive sheet 300 is heated to form an adhesive layer. The double-sided adhesive sheet 300 is bonded to the outside of the touch screen 200 in a state in which one surface of the double-sided adhesive sheet is heated so as to be bonded to the touch screen 200, thereby bonding the touch screen 200 to the display unit 100.

The optical transparent sheet 400 removes the air gap between the display unit 100 and the touch screen 200, thereby improving visibility of the image displayed to a user. In addition, the optical transparent sheet 400 is not bonded but contacted to the display unit 100. As a result, when defects occur in the touch screen 200, the display unit 100 can be easily detached from the touch screen 200 by removing only the adhesion of the double sided adhesive sheet 300.

At this time, if the optical transparent sheet 400 has the same thickness as that of the double-sided adhesive sheet 300, it is possible to completely remove the air gap between the display unit 100 and the touch screen 200 and reinforce adhesion between the display unit 100 and the touch screen 200. When the optical transparent sheet 400 has a thickness smaller than that of the double-sided adhesive sheet 300, a small amount of air gap may occur between the optical transparent sheet 400 and the display unit 100. When the optical transparent sheet 400 has a thickness larger than that of the double-sided adhesive sheet 300, adhesion between the display unit 100 and the touch screen 200 may be weakened.

In addition, it is preferable that the inner side surface 310 of the double-sided adhesive sheet 300 contacts the outer side surface 410 of the optical transparent sheet 400 positioned inside the double-sided adhesive sheet 300.

As shown in FIG. 1, when the double-sided adhesive sheet 300 is positioned at two edge portions of the edge region E, opposite to each other, and the optical transparent sheet 400 is positioned inside the double-sided adhesive sheet 300, if the inner side surface 310 of the double-sided adhesive sheet contacts the outer side surface 410 of the optical transparent sheet 400, the adhesive layer formed between the display unit 100 and the touch screen 200 is not provided with an empty space seen from the top, thereby making it possible to remove the air gap. In addition, the adhesive layer entirely supports a lower substrate of the touch screen 200, thereby making it possible to prevent the touch screen 200 from being modified.

As shown in FIG. 2, in a display device having a touch screen 10′ (hereinafter, referred to as a display device), it is preferable that the outer side surface 410 of the optical transparent sheet 400 is surrounded by the inner side surface 310 of the double-sided adhesive sheet 300. At this time, the double-sided adhesive sheet 300 is formed to entirely cover the edge region E of the touch screen 200, while having the empty inner side. When the optical transparent sheet 400 is disposed in the empty inner side, the adhesion between the display unit 100 and the touch screen 200 is further reinforced and visibility is more improved by completely removing the air gap.

The display device 10′ according to the present embodiment may use an image providing device, such as a CRT monitor, a PDP, a LCD, or an OLED as the display unit 100.

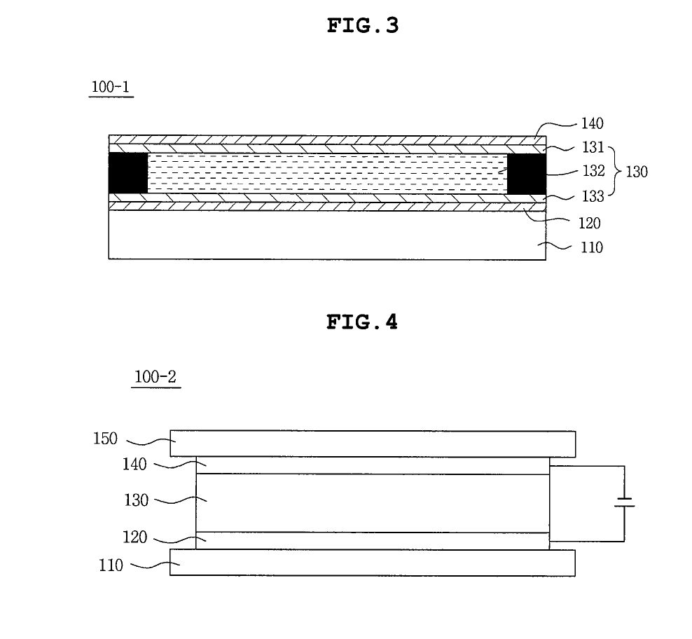

A LCD 100-1 includes a backlight unit 110, a first polarizer 120, a liquid crystal panel 130, and a second polarizer 140, as shown in FIG. 3.

The backlight unit 110 emits and supplies light to the liquid crystal panel 130, and is configured to include a lamp, a lamp reflector that surrounds the lamp, and a light guide plate. The first polarizer 120 is positioned on the upper side of the backlight unit 110 and supplies a first polarization of the light emitted from the backlight unit, having a specific directionality, to the liquid crystal panel 130 to be described below.

The liquid crystal panel 130 is positioned on the upper side of the first polarizer 120 and receives the light emitted from the backlight unit 110 to generate an image. The liquid crystal panel 130 is configured to include an upper substrate 131 on which a transparent common electrode is formed and a lower substrate 133 on which array wirings including a pixel electrode and a switching device formed in a pixel region are formed, wherein a liquid crystal 132 is filled between the upper substrate and the lower substrate. The liquid crystal panel 130 may further include a color filter substrate (not shown) that is positioned on the upper side thereof.

The second polarizer 140 is positioned on the upper side of the liquid crystal panel 130 to transfer the image generated from the liquid crystal panel 130 to an outside user. The second polarizer 140 and the first polarizer 120 may have the polarizing characteristics identical or vertical to each other, which can be changed according to whether the LCD 100-1 is in a normally white type or a normally black type.

When the second polarizer 140 forms the top layer of the LCD 100-1 as described above, the second polarizer 140 is bonded to the touch screen 200 through the adhesive layer. Meanwhile, when a protective layer (not shown) formed of a transparent member is further positioned on the upper side of the second polarizer 140, the protective layer is bonded to the touch screen 200 through the transparent adhesive sheet.

The display unit may use an OLED 100-2. The OLED 100-2 has a structure in which the first electrode layer 120, the organic light emitting layer 130, the second electrode layer 140, and the upper substrate 150 are sequentially stacked on the lower substrate 110, as shown in FIG. 3.

In the case of a top emission type OLED, the first electrode layer 120 forms an anode electrode layer, and the second electrode layer 130 forms a cathode electrode layer. Holes from the anode electrode layer and electrons from the cathode electrode layer are injected into an organic light emitting layer, and the injected electrons and holes are recombined in the organic light emitting layer. Energy level becomes high from a stable ground state to an unstable excited state having high energy due to the recombined energy. When the energy level returns to the original ground state, energy is discharged and at this time, light is generated. Therefore, the OLED 100-2 can be emitted by itself, without having a separate backlight as in the liquid crystal display device. The layer structure of the OLED 100-2 may vary according to its configuration and it is publicly known and thus, the detailed description thereof will be omitted.

Even when the display unit 100 uses the OLED 100-2, the upper substrate 150 of the OLED 100-2 formed of a transparent member is bonded to the touch screen 200 through the double-sided adhesive sheet 300 and the optical transparent sheet 400.

The display device 10 according to the present invention may use a resistive touch screen, a capacitive touch screen, or the like.

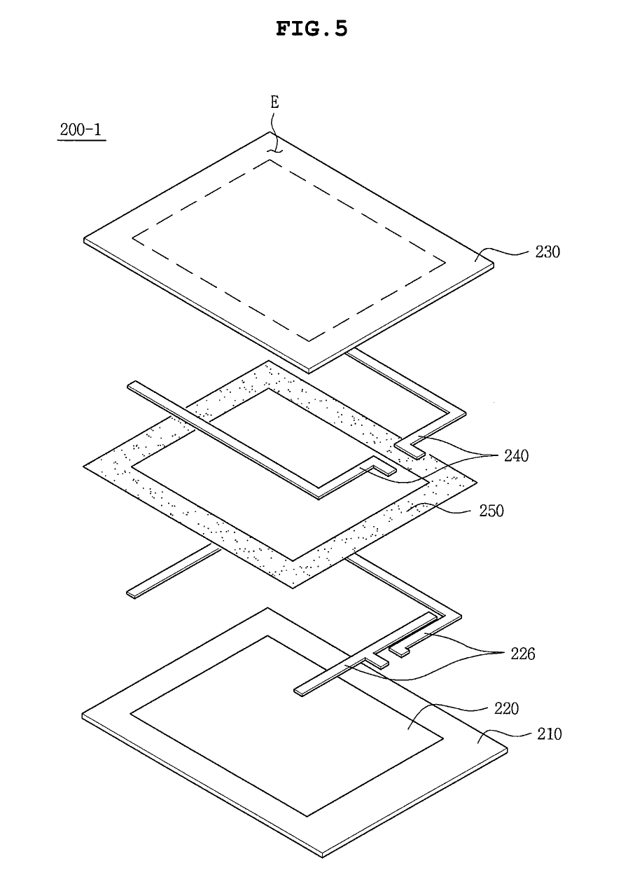

A resistive touch screen 200-1 includes two substrates 210 and 230 having electrode patterns formed on surfaces opposite to each other, as shown in FIG. 5.

First, first electrode patterns 220 are formed in an active region of the first substrate 210 (lower substrate) and first electrode wiring 226 connected to the first electrode patterns 220 are formed in an inactive region (edge region) of the first substrate 210. In the analog resistive touch screen 200-1 as shown in FIG. 5, the first electrode patterns 220 are formed in a thin resistive film and two first electrode wirings 226 are connected to the resistive film and formed in a Y direction.

At this time, the first substrate 210 may use a glass substrate, a film substrate, a fiber substrate, and a paper substrate, and is not specifically limited.

In addition, the first electrode pattern 220 may be made of ITO, a carbon nanotube and a transparent conductive polymer, and the first electrode wiring 226 may be made of the same material as that of the first electrode pattern or silver (Ag). The conductive polymer may include an organic compound, such as polythiophene, polypyrrole, polyaniline, polyacetylene, polyphenylene polymers. In particular, among the polythiophene, poly-3,4-ethylenedioxythiophene/polystyrenesulfonate (PEDOT/PSS) compound is most preferable and at least one of the organic compound may be mixed.

The second substrate 230 (upper substrate) is disposed to be spaced from the first substrate 210, and similarly includes a second electrode patterns (not shown) and second electrode wirings 246 formed on a surface opposite to the surface on which the first electrode patterns 220 are formed. The second electrode patterns also have a thin film shape and are connected to the second electrode wirings 246. At this time, the second electrode wirings 246 are connected to the resistive film and formed in an X direction.

In the case of the resistive touch screen 200-1, when a user contacts the touch screen, the electrode patterns formed on two substrates are contacted and the change in voltage is measured, thereby detecting coordinates of the contact point. Therefore, a spacer 250 has a shape in which its inner side is open so that the two substrates are spaced from each other but the two electrode patterns are contacted by external pressure.

Meanwhile, although a 4-wire touch screen panel of the analog resistive touch screen panels is shown in FIG. 5, the number of electrode wiring may vary according to schemes. In the case of a digital resistive touch screen, a plurality of electrode patterns are formed, having a bar shape, and thus the number of electrode wirings increases.

Although not shown in FIG. 5, the opposite surface of the first substrate 210 or the second substrate 230 may further include a dot spacer made of insulating synthetic resin such as epoxy, acryl resin, or the like, so that the electrode patterns erroneously contact each other due to light pressure.

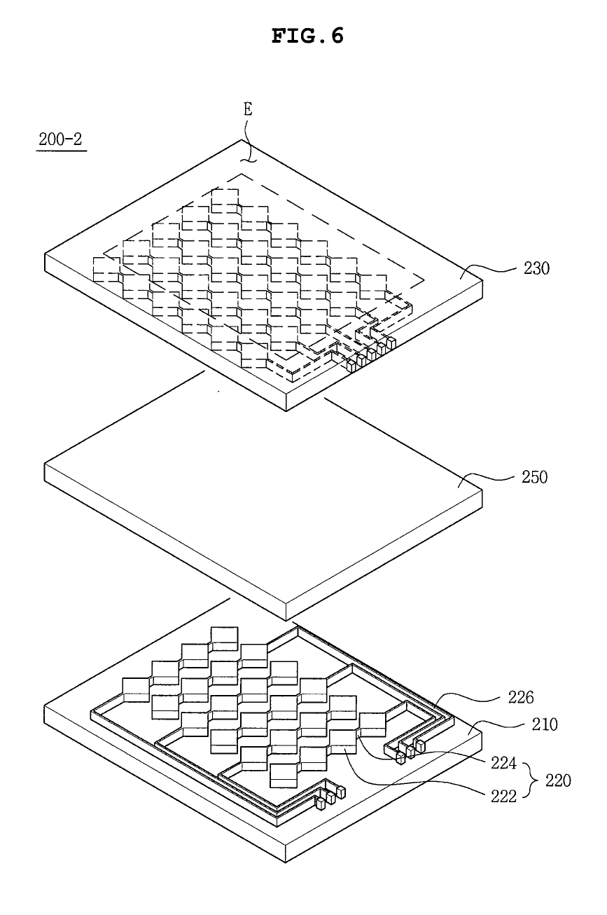

A capacitive touch screen 200-2 also includes two substrates 210 and 230 that are disposed to be opposite to each other, wherein a spacer 250 is disposed between the first substrate 210 and the second substrate 230 so that the first substrate 210 is spaced from the second substrate 230, as shown in FIG. 6. The spacer 250 may be made of transparent plastic to be bonded by a transparent adhesive or may use a transparent adhesive sheet having a predetermined thickness.

At this time, a plurality of first electrode patterns 220 are formed on the first substrate 210 (lower substrate) in a first direction (Y direction) in parallel. The first electrode pattern 220 includes a sensing unit 222 and a connection unit 224, wherein the sensing unit 222 and the connection unit 224 are repeated. At this time, the sensing unit 222 is a portion that the change in capacitance is sensed when a user's hand touches the touch screen, and the connection unit 224 is a portion to connect adjacent sensing units 222.

Meanwhile, although the sensing unit 222 has a diamond shape in FIG. 6, it is just one example but may have various shapes, such as a hexagonal shape or an octagonal shape.

The first electrode wirings 226 connected to the first electrode patterns 220 are formed on the first substrate 210. The first electrode wirings 226 connected to the first electrode patterns 220 are disposed so that the first electrode wirings 226 are extended to the edge region of the first substrate 210 and the ends thereof are collected at the connection unit of the first substrate 210. The connection unit is connected to a FPCB (not shown) to transfer the change in capacitance of the first electrode patterns 220 to a controller (not shown).

At this time, the first substrate 210 may be made of a glass substrate or a film substrate, similar to the first substrate 110 as shown in FIG. 3.

The second substrate 230 (upper substrate) is disposed to be spaced from the first substrate 210 and includes a plurality of second electrode patterns and second electrode wirings formed on a surface opposite to the surface on which the first electrode patterns 220 are formed.

In the case of the capacitive touch screen 200-2, when a user's fingers, etc. touch the touch screen, the change in capacitance due to the operation between the electrode patterns and fingers is measured, thereby detecting coordinates of the touched points. Therefore, it is preferable that the spacer 250 is spatially detached completely so that the electrode patterns formed on the two substrates 210 and 230 do not contact each other.

According to the present invention, when bonding the touch screen to the display unit, the optical transparent sheet inside the double-sided adhesive sheet is not bonded to the display unit and the touch screen is bonded to the display unit through the double-sided adhesive sheet positioned in the edge region of the touch screen to minimize a contact area, such that when defects occur in the touch screen, the touch screen can be easily detached from the display unit.

In addition, the optical transparent sheet is positioned inside the double-sided adhesive sheet so as not to form an air gap between the touch screen and the display unit, such that an image generated from the display unit can be more clearly transferred to a user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A display device having a touch screen, comprising:
a display unit;
a touch screen that is positioned on the upper side of the display unit;
a double-sided adhesive sheet that is positioned between the display unit and the touch screen and is disposed in the edge region of the touch screen to bond the display unit to the touch screen; and
an optical transparent sheet that is positioned inside the double-sided adhesive sheet and is bonded to the touch screen and is contacted to the display unit.

2. The display device having a touch screen as claimed in claim 1, wherein the optical transparent sheet has the same thickness as that of the double-sided adhesive sheet.

3. The display device having a touch screen as claimed in claim 1, wherein the inner side surface of the double-sided adhesive sheet contacts the outer side surface of the optical transparent sheet positioned inside the double-sided adhesive sheet.

4. The display device having a touch screen as claimed in claim 3, wherein the outer side surface of the optical transparent sheet is surrounded by the inner side surface of the double-sided adhesive sheet.

5. The display device having a touch screen as claimed in claim 1, wherein the display unit is an LCD.

6. The display device having a touch screen as claimed in claim 1, wherein the display unit is an OLED.

7. The display device having a touch screen as claimed in claim 1, wherein the touch screen is a capacitive touch screen.

8. The display device having a touch screen as claimed in claim 1, wherein the touch screen is a resistive touch screen.
